(19) United States
(12) Patent Application Publication
(10) Pub. No.: US 2013/0340981 A1
(43) Pub. Date: Dec. 26, 2013

(54) ELECTROHYDRODYNAMIC (EHD) AIR MOVER CONFIGURATION WITH FLOW PATH EXPANSION AND/OR SPREADING FOR IMPROVED OZONE CATALYSIS

(71) Applicant: TESSERA, INC., San Jose, CA (US)

(72) Inventors: Nels Jewell-Larsen, San Jose, CA (US); Bong-Sub Lee, Mountain View, CA (US); Kenneth Honer, Santa Clara, CA (US); Giles Humpston, Buckinghamshire (GB)

(73) Assignee: TESSERA, INC., San Jose, CA (US)

(21) Appl. No.: 13/737,464

(22) Filed: Jan. 9, 2013

Related U.S. Application Data
(60) Provisional application No. 61/584,793, filed on Jan. 9, 2012.

(51) Int. Cl. F24F 7/007; G06F 1/20

(52) U.S. Cl. CPC F24F 7/007; G06F 1/20
USPC 165/120; 29/592.1

(57) ABSTRACT

Provision of an expansion region (e.g., a flow path with increasing cross-section downstream of the EHD air mover) can provide operational benefits in EHD air mover-based thermal management systems. In contrast, such a design would generally be disfavored for conventional mechanical air mover-based systems. In some cases, an expansion chamber or volume may be provided between the EHD air mover and heat transfer surfaces. In some cases, expansion of the flow cross-section may be provided (at least in part) within the heat transfer surface volume itself. In some cases, leading surfaces of heat transfer surface (e.g., heat sink fins) may be shaped, disposed or otherwise presented to EHD motivated flow to reduce “laminarity” of the impinging air flow so as to reduce thermal transfer boundary layer effects and/or to divert flow outward in the flow channel so as to more evenly distribute ozone molecules over catalytic sites.

### CROSS-REFERENCE TO RELATED APPLICATION(S)

The present application claims priority of Provisional Application No. 61/584,793, filed Jan. 9, 2012, the entirety of which is incorporated herein by reference.

### BACKGROUND

1. Field

The present application relates to devices that generate ions and electrical fields to motivate flow of fluids, such as air, and more particularly, to small form-factor, electrohydrodynamic (EHD) air movers suitable for use as part of a thermal management solution to dissipate heat.

2. Related Art

Many modern electronic devices (including desktop and laptop computers, all-in-one computers, televisions, video displays and projectors) employ forced air flow as part of a thermal management solution. Mechanical air movers such as fans or blowers have conventionally been employed in many such devices. However, in some applications and devices, mechanical air mover operation may result in undesirable levels of noise or vibration that may degrade the user experience. In some cases, physical scale or flow paths that would otherwise be necessary to accommodate a mechanical air mover may be incompatible with, or unacceptably limit, the design, scale or form factor of a particular design. Worse still, at the extremely thin device form factors popular in certain consumer electronics (e.g., laptops, pad-type computers, televisions, smartphones, book readers and media players), mechanical air mover designs (if even accommodatable) tend to exhibit poor cooling efficiencies. As a result, battery life may be adversely affected or, as a practical matter, device performance throttled to a level compatible with passive cooling.

Technologies have been developed that employ electric fields and principles of ionic movement of a fluid to motivate air flow. Devices that operate based on such principles are variously referred to in the literature as ionic wind machines, electric wind machines, corona wind pumps, electro-fluid-dynamics (EFD) devices, electrohydrodynamic (EHD) thrusters and EHD gas pumps. Some aspects of the technology have been exploited in devices referred to as electrostatic air cleaners or electrostatic precipitators and, indeed, some practical large scale device applications of the technology date back to the early 1900s. More recently, researchers have considered the utility of EHD air movers as part of a thermal management solution in consumer electronics devices. See generally, N. E. Jewell-Larsen, H. Ran, Y. Zhang, M. Schwiebert and K. A. Honer, Electrohydrodynamic (EHD) Cooled Laptop, in proceedings of 25th Annual Semiconductor Thermal Measurement and Management Symposium (March 2009).

In some cases, an ion flow or EHD air mover may improve cooling efficiency and thermal management in some devices and/or applications, while reducing noise, vibration and power consumption. Likewise, EHD air mover designs may provide or facilitate systems or devices that have reduced overall device lifetime costs, device size or volume, and/or improved electronic device performance or user experience.

Ozone (O₃), while naturally occurring, can also be produced during operation of various electronics devices including EHD devices, photocopiers, laser printers and electrostatic air cleaners, and by certain kinds of electric motors and generators, etc. At high concentrations, ozone can be undesirable and, accordingly, techniques to reduce ozone concentrations are desired. Indeed, techniques have been developed to catalytically or reactively break down ozone (O₃) into the more stable diatomic molecular form (O₂) of oxygen. See e.g., U.S. Pat. No. 6,603,268 to Lee and U.S. Patent Application Publication 2010-0116469, naming Jewell Larsen et al. as inventors, each of which is commonly-owned by the assignee of the present application.

### SUMMARY

It has been discovered that while electrohydrodynamic (EHD) air movers and mechanical air movers such as fans and blowers may play analogous roles in thermal management systems, differences in their operational characteristics tend to complicate the simple replacement of a mechanical air mover with an EHD air mover and, as will be appreciated by persons of ordinary skill in the art having benefit of the present disclosure, tend to favor practical implementations in which different design goals are emphasized. For example, it has been discovered that while thermal management systems based on mechanically forced air flow tend to perform best when the highly turbulent outflow of a fan or blower motivates large volumes of air per unit time over heat transfer surfaces with small ΔT (change in temperature), such design goals and operating characteristics may not transfer well to designs in which an EHD air mover is, instead, employed. Indeed, it has been discovered that a typical design goal of thermal management systems based on mechanically forced air flow, i.e., that flow cross-sections of the fan or blower be sized to match that of a heat sink, may not be desirable for designs in which an EHD air mover motivates flow. Rather, because in some cases heat transfer surfaces may be an attractive site for thermally-enhanced ozone reducing catalysis, practical EHD air mover-based designs may seek to significantly reduce velocity of motivated airflows to allow greater interaction time with the catalyst. Furthermore, in some embodiments, strategies for diverting or otherwise facilitating dispersal of ozone molecules over a more complete portion of catalyst bearing heat transfer surfaces may be desirable.

It has been discovered that, in particular, provision of an expansion region (e.g., a flow path with increasing cross-section downstream of the EHD air mover) can provide operational benefits in EHD air mover-based thermal management systems. In contrast, such a design would generally be disfavored for conventional mechanical air mover-based systems. In some cases, an expansion chamber or volume may be provided between the EHD air mover and heat transfer surfaces. In some cases, expansion of the flow cross-section may be provided (at least in part) within the heat transfer surface volume itself. In some cases, leading surfaces of heat transfer surface (e.g., heat sink fins) may be shaped, disposed or otherwise presented to EHD motivated flow to reduce “laminarity” of the impinging air flow so as to reduce thermal transfer boundary layer effects. Again, such variations would generally be disfavored, and indeed unnecessary, for conventional mechanical air mover-based systems in which airflow is already highly turbulent. These and other variations will be appreciated by persons of ordinary skill in the art having benefit of the present disclosure.

In some embodiments in accordance with the present invention, a ventilation path includes an electrohydrodynamic (EHD) air mover, an array of spaced apart heat transfer fins and an expansion region. The EHD air mover has, at its output, a flow channel characterized by a first cross-section through which, when the EHD air mover is energized, motivated air flow is essentially laminar. The array of spaced apart heat transfer fins present to the motivated air flow a second cross-section larger than the first cross-section. The expansion region is of increasing cross-section along the path of the motivated air flow from the output of the EHD air mover toward the second cross-section.

In some embodiments, the increasing cross-section provided within the expansion region provides for a reduction of at least about 20% to 80% in velocity of the motivated air flow at the second cross-section as compared with velocity of the motivated air flow at the first cross-section. In some cases, the output of the EHD air mover coincides with a trailing edge of at least a pair elongate collector electrode surfaces oriented parallel to an upstream emitter wire having a cross-section of less than about 40 μm, and the first cross-section is generally rectangular with a height of less than about 10 mm, with a length:height ratio of at least 10:1.

In some embodiments, the first and second cross-sections have substantially similar heights, ±10%, but length of the second cross-section substantially exceeds that of the first cross-section. In some embodiments, the first and second cross-sections have substantially similar lengths, ±10%, but height of the second cross-section substantially exceeds that of the first cross-section.

In some embodiments, at least a substantial portion of surfaces of the heat transfer fins exposed to the motivated air flow are coated with an ozone reducing catalyst; and mean transit time of the motivated air flow through the heat transfer fins is at least about 0.3 seconds. In some cases, the heat transfer fins extend no more than about 25 mm along the path of the motivated air flow.

In some embodiments, at least a substantial portion the expansion region is between the output of the EHD air mover and leading edges of the spaced apart heat transfer fins. In some embodiments, leading portions of at least some of the spaced apart heat transfer fins project into the expansion region. In some embodiments, a substantial entirety of the expansion region is between the output of the EHD air mover and leading edges of at least some of the spaced apart heat transfer fins. In some cases, height of the first cross-section at the output of the EHD is less than about 10 mm, and the second cross-section is at least about 20% to 80% larger than the first cross-section. In some cases, the second cross-section is at least about 20% to 200% larger than the first cross-section.

In some embodiments, the expansion region encompasses leading portions of at least some of the spaced apart heat transfer fins. In some embodiments, leading edges of at least some of the spaced apart heat transfer fins are shaped or disposed to redirect at least a portion of the motivated air flow. In some cases, the shaping or disposition to redirect includes an angled presentation of the leading edges to the motivated air flow. In some cases, the shaping or disposition to redirect includes an upstream projection into the motivated air flow of at least some of the spaced-apart heat transfer fins. In some cases, the leading edges shaped or disposed to redirect are positioned within the ventilation path to coincide with a concentration in a non-uniform spatial distribution of ozone motivated air flow.

In some embodiments, the increasing cross-section is provided in plural dimensions generally orthogonal to the path of the motivated air flow. In some embodiments, the ventilation path is integrated in an electronic device as part of a thermal management subsystem thereof. In some cases, at least a portion of a flow path defining boundary wall is provided by either or both of: an enclosure of the electronic device; and ductwork within the electronic device

In some embodiments, the ventilation path is embodied as part of a thermal management subsystem suitable for integration within in an electronic device between an inlet and an outlet ventilation boundary thereof. In some cases, at least a portion of a flow path defining boundary wall is provided by the thermal management subsystem itself.

In some embodiments in accordance with the present invention, a ventilation path includes an electrohydrodynamic (EHD) air mover, an array of spaced-apart heat transfer fins and a flow spreader. The EHD air mover has, at its output, a flow channel characterized by a first cross-section through which, when the EHD air mover is energized, motivated air flow is essentially laminar and unidirectional. The array of spaced-apart heat transfer fins bear an ozone reducing catalyst and present to the motivated air flow a second cross-section. The flow spreader is introduced into the ventilation path downstream of the output of the EHD air mover, but no further downstream than a mid-channel leading edge of the spaced apart heat transfer fins.

In some embodiments, the motivated air flow through the first cross-section exhibits a spatially non-uniform distribution of ozone and the flow spreader diverts at least some of the motivated air flow from a region of generally higher ozone concentration such that a spatial distribution of ozone at the second cross-section is substantially more uniform than at the first cross-section.

In some embodiments, the flow spreader is formed, at least in part, as a leading edge of at least some of the spaced-apart heat transfer fins shaped or disposed to contribute to the diversion. In some cases, the shaping or disposition to contribute to the diversion includes an upstream projection of at least some of the spaced-apart heat transfer fins. In some cases, the shaping or disposition to contribute to the diversion includes an angled presentation of the leading edges to the motivated air flow.

In some embodiments, the EHD air mover includes a laterally elongate wire-type emitter electrode vertically positioned at or about a vertical midpoint in the flow channel and the flow spreader is vertically positioned downstream of the emitter electrode to generally align and vertically coincide with a flow path of ozone generated proximate to the emitter electrode.

In some embodiments in accordance with the present invention, a method of making an electronic device includes introducing into a ventilation path of the electronic device (i) an electrohydrodynamic (EHD) air mover having, at its output, a flow channel characterized by a first cross-section through which, when the EHD air mover is energized, motivated air flow is essentially laminar and unidirectional and (ii) downstream of the EHD air mover, an array of spaced-apart heat transfer fins that bear an ozone reducing catalyst and which present to the motivated air flow a second cross-section, the EHD air mover and array of spaced-apart heat transfer fins separated by an expansion region of increasing cross-section along the path of the motivated air flow from the output of the EHD air mover toward the second cross-section. The method further includes providing a flow spreader in the ventilation path downstream of the output of the EHD air mover, but no further downstream than a mid-channel leading edge of the spaced apart heat transfer fins.

In some embodiments, the electronic device is packaged as one of a computer, a laptop, notebook, tablet or handheld electronic device and a video display, and the method further includes configuring the EHD device to provide the computer, laptop, notebook, tablet or handheld electronic device or video display with ventilating air flow.

### BRIEF DESCRIPTION OF THE DRAWINGS

The present invention may be better understood, and its numerous objects, features, and advantages made apparent to those skilled in the art by referencing the accompanying drawings.

FIG. 1 is a graphic depiction of certain basic principles of electrohydrodynamic (EHD) fluid flow in a corona discharge type device.

FIG. 2 depicts an illustrative EHD fluid mover electrode geometry.

FIG. 3 depicts an illustrative electrohydrodynamic (EHD) fluid mover configuration in which emitter and collector electrodes are energized to motivate fluid flow and which includes (as illustrated in side cross-sectional view) an expansion region between the EHD fluid mover and heat transfer fins in accordance with some embodiments of the present invention.

FIG. 4 depicts another illustrative EHD fluid mover configuration in which an emitter electrode and an array of collector electrodes are energized to motivate fluid flow and which includes (as illustrated in side cross-sectional view) an expansion region that is provided in accordance with some embodiments of the present invention within a volume occupied by heat transfer surfaces.

FIGS. 5A and 5D depict, in perspective view, further illustrative EHD fluid mover configurations in which an expansion region is provided. FIG. 5A depicts a configuration in which a lateral extent of the heat transfer fin presentation is greater (in a horizontally illustrated dimension) than EHD fluid mover. FIGS. 5B and 5C are cross-sectional views corresponding to FIG. 5A. FIG. 5D likewise depicts a configuration in which a lateral and vertical extent of the heat transfer fin presentation is greater than corresponding extents of the EHD fluid mover. FIGS. 5E and 5F are cross-sectional views corresponding to FIG. 5D. Finally, FIG. 5G is a top, plan view corresponding to both FIGS. 5A and 5D.

FIGS. 6A, 6B, 6C, and 6D depict, in simplified side cross-sections, several variations on shaping and leading edge presentation of heat transfer fins to an EHD motivated airflow. Shaping and leading edge presentations illustrated in FIGS. 6B, 6C, and 6D tend to contribute to dispersion of ozone (generated proximate an emitter electrode) over ozone catalyst bearing surfaces of the heat transfer fins as compared to the unaided diffusion illustrated in FIG. 6A. FIG. 6E is a perspective view to illustrate dissimilar leading edge presentations amongst an array of heat transfer fins.

FIG. 7 depicts yet another illustrative EHD fluid mover configuration in which an emitter electrode and collector electrodes are energized to motivate fluid flow and which includes (as illustrated in side cross-sectional view) an expansion and flow diversion region that is provided in accordance with some embodiments of the present invention(s).

FIG. 8 depicts still another illustrative EHD fluid mover configuration in which an emitter electrode and collector electrodes are energized to motivate fluid flow and which includes (as illustrated in side cross-sectional view) a flow diversion region that is provided in accordance with some embodiments of the present invention(s).

FIGS. 9 and 10 depict illustrative electronic device embodiments in which illustrative EHD fluid mover and heat transfer fins configurations are provided in accordance with some embodiments of the present invention(s).

FIGS. 11A and 11B depict an illustrative display-type electronic device embodiments in which illustrative EHD fluid mover and heat transfer fins configurations are provided in accordance with some embodiments of the present invention(s).

The use of the same reference symbols in different drawings indicates similar or identical items.

### DESCRIPTION OF THE PREFERRED EMBODIMENT(S)

As will be appreciated, many of the designs and techniques described herein have particular applicability to the thermal management challenges of densely-packed devices and small form-factors typical of modern consumer electronics. Indeed, some of the EHD fluid/air mover designs and techniques described herein facilitate active thermal management in electronics whose thinness or industrial design precludes or limits the viability of mechanical air movers such as fans, blowers, etc. In some embodiments, such EHD fluid/air movers may be fully integrated in an operational system such as a pad-type or laptop computer, a projector or video display device, a set-top box, etc. In other embodiments, such EHD fluid/air movers may take the form of subassemblies or enclosures adapted for use in providing such systems with EHD motivated flows.

In general, a variety of scales, geometries and other design variations are envisioned for emitter and/or collector electrodes (as well as other electrostatically operative surfaces) of a given EHD device. For purposes of illustration, we focus on certain exemplary embodiments and certain surface profiles and positional interrelationships with other components. For example, in much of the description herein, generally planar collector electrodes are formed as or on respective parallel surfaces that define opposing walls of a fluid flow channel and which are positioned proximate to a corona discharge-type emitter wire that is displaced (upstream) from leading portions of the respective collector electrodes. Nonetheless, other embodiments may employ other configurations or other ion generation techniques and will nonetheless be understood in the descriptive context provided herein.

Although the present description focuses primarily on spatial relations between EHD air mover and heat exchange portions of a thermal management solution, based on the description herein, persons of ordinary skill in the art will appreciate specializations and variations for any of a wide variety of electronic device configurations. Indeed, commonly-owned, co-pending U.S. patent application Ser. No. 13/105,343, filed May 11, 2011, and commonly-owned, co-pending U.S. patent application Ser. No. 13/310,676, filed Dec. 2, 2011, are each incorporated herein by reference for the purpose of an exemplary subset of illustrative electronic device configurations.

In the present application, some aspects of embodiments illustrated and described herein are referred to as electrohydrodynamic fluid accelerator devices, also referred to as “EHD devices,” “EHD fluid accelerators,” “EHD fluid movers,” “ion fluid movers” and the like. For purposes of illustration, some embodiments are described relative to particular EHD device configurations in which a corona discharge at, or proximate to, an emitter electrode operates to generate ions that are accelerated in the presence of an electrical field, thereby motivating fluid flow. While corona discharge-type devices provide a useful descriptive context, it will be understood (based on the present description) that other ion generation techniques may also be employed. For example, in some embodiments, techniques such as silent discharge, AC discharge, dielectric barrier discharge (DBD), or the like, may be used to generate ions that are in turn accelerated in the presence of an electrical field and motivate fluid flow.

Using heat transfer surfaces that, in some embodiments, take the form of heat transfer fins, heat dissipated by electronics (e.g., microprocessors, graphics units, etc.) and/or other components can be transferred to the EHD motivated fluid flow and exhausted from an enclosure through a ventilation boundary. Typically, when a thermal management system is integrated into an operational environment, heat transfer paths (often implemented as heat pipes or using other technologies) are provided to transfer heat from where it is dissipated (or generated) to a location (or locations) within the enclosure where air flow motivated by an EHD device (or devices) flows over heat transfer surfaces.

For Illustration, heat transfer fins are depicted with respect to various exemplary embodiments. However, as will be appreciated based on the description herein, in some embodiments, conventional arrays of heat sink fins need not be provided in all embodiments and EHD motivated fluid flow over exposed interior surfaces, whether proximate a heat generating device (such as a processor, memory, RF section, optoelectronics or illumination source) or removed therefrom, may provide sufficient heat transfer. In each case, provision of ozone catalytic or reactive surfaces/materials on heat transfer surfaces may be desirable.

### Electrohydrodynamic (EHD) Fluid Acceleration, Generally

Basic principles of electrohydrodynamic (EHD) fluid flow are well understood in the art and, in this regard, an article by Jewell-Larsen, N. et al., entitled “Modeling of corona-induced electrohydrodynamic flow with COMSOL multiphysics” (in the Proceedings of the ESA Annual Meeting on Electrostatics 2008) (hereafter, “the Jewell-Larsen Modeling article”), provides a useful summary. Likewise, U.S. Pat. No. 6,504,308, filed Oct. 14, 1999, naming Krichtafovitch et al. and entitled “Electrostatic Fluid Accelerator” describes certain electrode and high voltage power supply configurations useful in some EHD devices. U.S. Pat. No. 6,504,308, together with sections I (Introduction), II (Background), and III (Numerical Modeling) of the Jewell-Larsen Modeling article are hereby incorporated by reference herein for all that they teach.

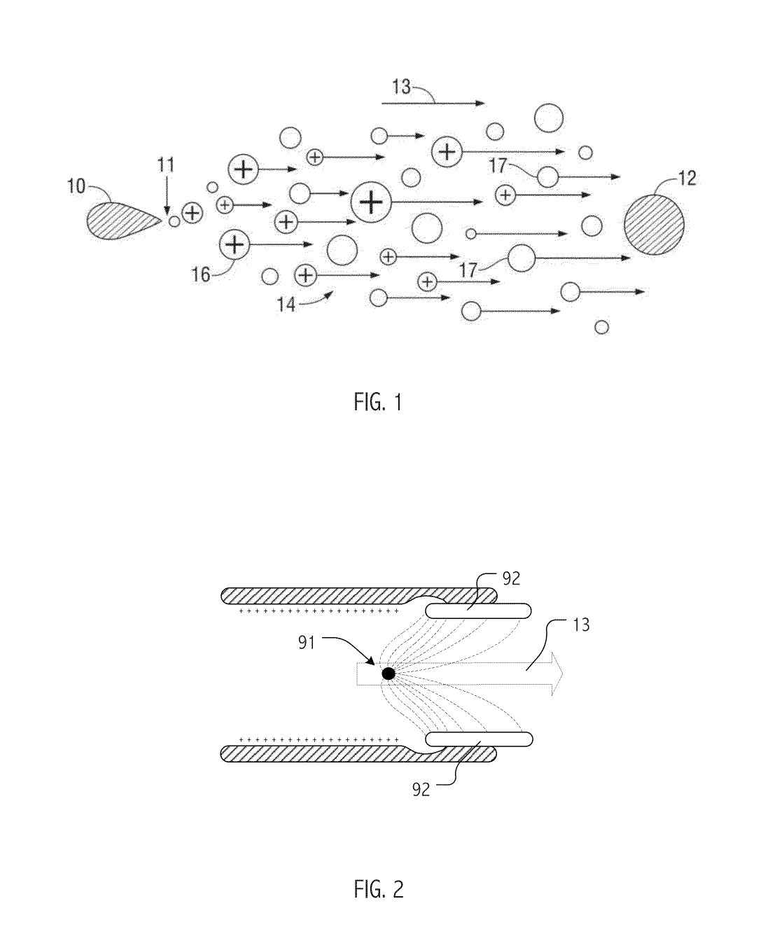

Summarizing briefly with reference to the illustration in FIG. 1, EHD principles include applying a high intensity electric field between a first electrode 10 (often termed the “corona electrode,” the “corona discharge electrode,” the “emitter electrode” or just the “emitter”) and a second electrode 12. Fluid molecules, such as surrounding air molecules, near the emitter discharge region 11 become ionized and form a stream 14 of ions 16 that accelerate in the electric field toward second electrode 12, colliding with neutral fluid molecules 17 in the process. As a result of these collisions, momentum is transferred from the stream 14 of ions 16 to the fluid molecules 17, imparting corresponding movement of the fluid molecules 17 in a desired fluid flow direction, denoted by arrow 13, toward second electrode 12. Second electrode 12 may be variously referred to as the “accelerating,” “attracting,” “target” or “collector” electrode. While stream 14 of ions 16 is attracted to, and generally neutralized by, second electrode 12, the momentum transferred to the neutral fluid molecules 17 carries them past second electrode 12 at a certain velocity. The movement of fluid produced by EHD principles has been variously referred to as “electric,” “corona” or “ionic” wind and has been defined as the movement of gas induced by the movement of ions from the vicinity of a high voltage discharge electrode 10.

FIG. 2, in turn, illustrates in cross-section, a practical EHD air mover design for thin form factor applications, which builds on EHD principals and in which an ion flow from emitter electrode 91 toward surfaces of collector electrodes 92 transfers momentum to air molecules. The result is a net flow in the downstream direction denoted by arrow 13.

EHD fluid mover designs illustrated herein generally include a single elongate wire, corona discharge type emitter electrode, although (more generally) multiple emitter electrodes and other emitter geometries may be employed. Typically, corona discharge type emitter electrodes include a portion (or portions) that exhibit(s) a small radius of curvature and may take the form of a wire, rod, edge or point(s). Other shapes for corona discharge electrodes are also possible; for example, the corona discharge electrode may take the shape of barbed wire, wide metallic strips, and serrated plates or non-serrated plates having sharp or thin parts that facilitate ion production at the portion of the electrode with the small radius of curvature when high voltage is applied.

In general, emitter electrodes may be fabricated in a wide range of materials. For example, in some embodiments, a corona discharge type emitter electrode is formed of Palladium Nickel (PdNi) plated Tungsten (W) wire with a Rhodium (Rh) coating. See e.g., commonly-owned, co-pending U.S. patent application Ser. No. 13/302,811, filed Nov. 22, 2011, entitled “EMITTER WIRE WITH LAYERED CROSS-SECTION” and naming Gao, Jewell-Larsen and Humpston as inventors which is incorporated herein for a description of suitable and illustrative emitter wire metallurgy. In some embodiments, compositions such as described in U.S. Pat. No. 7,157,704, filed Dec. 2, 2003, entitled “Corona Discharge Electrode and Method of Operating the Same” and naming Krichtafovitch et al. as inventors may be employed. U.S. Pat. No. 7,157,704 is incorporated herein for the limited purpose of describing materials for some emitter electrodes that may be employed in some corona discharge-type embodiments. In general, a high voltage power supply creates the electric field between emitter and collector electrodes.

EHD fluid mover designs illustrated herein include ion collection surfaces positioned downstream of one or more corona discharge electrodes. Often, ion collection surfaces of an EHD fluid mover portion include leading surfaces of generally planar collector electrodes extending downstream of the corona discharge electrode(s). In small form factor designs that seek to minimize flow channel height, collector electrode surfaces may be positioned against, or may partially define opposing walls of, the flow channel. In some cases, a collector electrode may do double-duty as heat transfer surfaces. In some cases, a fluid permeable ion collection surface may be provided. In some cases, wire- or rod-type collector electrodes may be introduced in the flow channel instead of, or in addition to, electrode surfaces positioned against on along channel walls.

In general, collector electrode surfaces may be fabricated of, or with, any suitable conductive material or surface, such as aluminum or copper. Alternatively, as disclosed in U.S. Pat. No. 6,919,698 to Krichtafovitch, collector electrodes (referred to therein as “accelerating” electrodes) may be formed of a body of high resistivity material that readily conducts a corona current, but for which a result voltage drop along current paths through the body of high resistivity collector electrode material provides a reduction of surface potential, thereby damping or limiting an incipient sparking event. Examples of such relatively high resistance materials include carbon filled plastic, silicon, gallium arsenide, indium phosphide, boron nitride, silicon carbide, and cadmium selenide. U.S. Pat. No. 6,919,698 is incorporated herein for the limited purpose of describing materials for some collector electrodes that may be employed in some embodiments. Note that in some embodiments described herein, a surface conditioning or coating of high resistivity material (as contrasted with bulk high resistivity) may be employed.

In embodiments that employ wire- or rod-type collector electrodes, the multiple parallel collector electrodes surfaces may be formed as metal wires or may be made of cut or etched metal, or formed in some other fashion. In some cases, even a conductive dielectric may be acceptable. Typically, surface material of such wire- or rod-type collector electrodes is conductive, but need not be a particularly good conductor. Indeed, consistent with the description of the above incorporated '698 patent, collector electrodes may be fashioned of or coated with fairly high electrical resistance material. In general, collector electrode surfaces should be resistant to ion bombardment and ozone. Noble metal surfaces such as gold (Au) and platinum (Pt) group metals) are generally suitable as are Ni and stainless steel. A core material could be the same as the surface, but may also be different. Each wire- or rod-type collector strand can be fairly thick (at least when compared to the emitter electrode) at between 50 μm to 200 μm, so material strength may not be particularly critical. At smaller collector electrode cross-sections, tungsten (W), titanium (Ti), molybdenum and/or alloys thereof are options. As with other collector electrode geometries, a smooth surface finish is desirable.

In embodiments that employ wire-type collector electrodes, very fine wire cross-sections and frictionally engaged in-situ cleaning/conditioning, a mechanically robust, engineered electrode with high-strength electrode core material such as titanium, steel, tungsten, tantalum, molybdenum, nickel and alloys containing these metals and one or more hard and electrochemically robust layers of palladium (Pd), other platinum (Pt) group metals, palladium nickel (PdNi), etc. overlaid thereon may be desirable. In some cases, emitter electrode materials and metallurgy (see above) developed to withstand frictional cleaning/conditioning and/or resistance to erosion in the corona may also be employed in collector electrode designs.

### Expansion of Flow Path Cross-Section, Generally

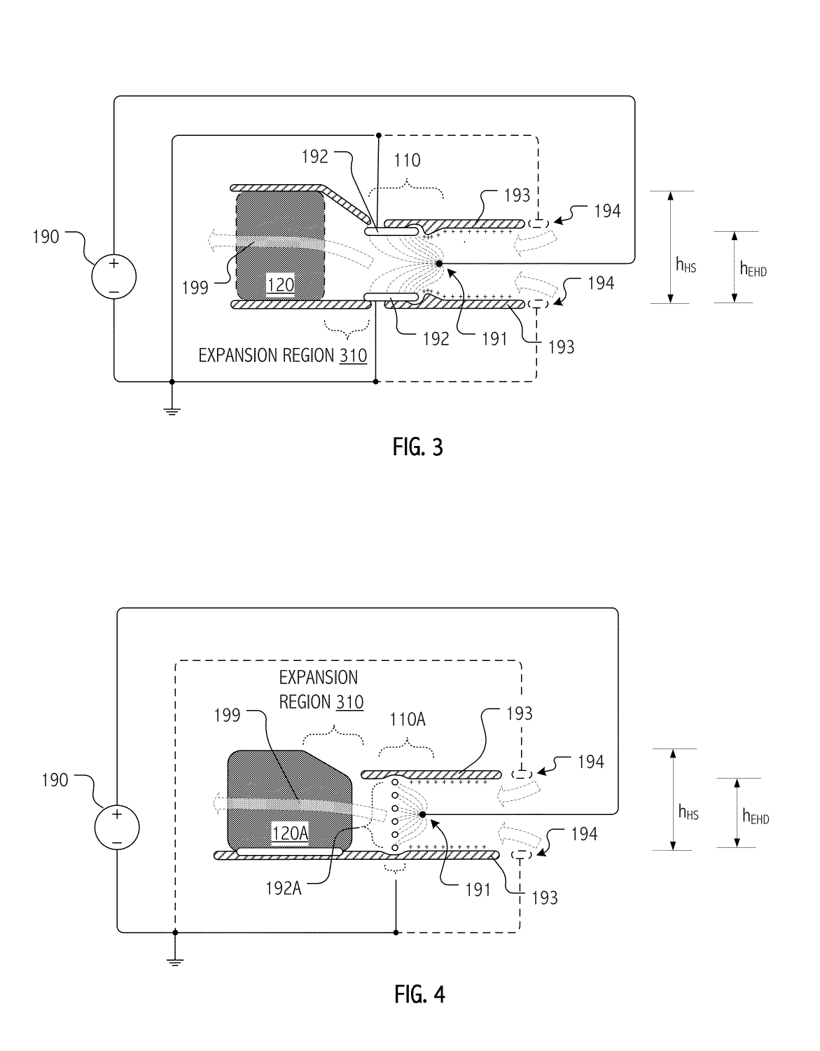

FIG. 3 depicts an illustrative electrohydrodynamic (EHD) fluid mover configuration in which emitter and collector electrodes are energized to motivate fluid flow and which includes (as illustrated in side cross-sectional view) an expansion region in accordance with some embodiments of the present invention between the EHD fluid mover and heat transfer fins.

Specifically, FIG. 3 depicts an illustrative EHD fluid mover configuration (with an illustrative power supply circuit schematic overlaid thereon) in which a high voltage power supply 190 is coupled between an emitter electrode 191 and collector electrodes 192 to generate an electric field and in some cases ions that motivate fluid flow 199 in a generally downstream direction. In the illustration, emitter electrode 191 is coupled to a positive high voltage terminal of power supply 190 (illustratively +3.5 KV, although specific voltages and, indeed, any supply voltage waveforms may be matters of design choice) and collector electrodes 192 are coupled to a local ground. See previously incorporated U.S. Pat. No. 6,508,308 for a description of suitable designs for power supply 190. Given the substantial voltage differential and short distances involved (perhaps 1 mm or less) between emitter electrode 191 and leading surfaces of collector electrodes 192, a strong electrical field is developed which imposes a net downstream motive force on positively charged ions (or particles) in the fluid. Field lines illustrate (generally) spatial aspects of the resulting electric field and spacing of the illustrated field lines is indicative of field strength.

As will be understood by persons of ordinary skill in the art, corona discharge principles may be employed to generate ions in the intense electric field closely proximate the surface of a corona-discharge type emitter electrode. Thus, in corona discharge type embodiments in accord with FIG. 3, fluid molecules (such as surrounding air molecules) near emitter electrode 191 become ionized and the resulting positively charged ions are accelerated in the electric field toward collector electrodes 192, colliding with neutral fluid molecules in the process. As a result of these collisions, momentum is transferred from the ions to neutral fluid molecules, inducing a corresponding movement of fluid molecules in a net downstream direction. While the positively charged ions are attracted to, and neutralized by, collector electrodes 192, the neutral fluid molecules move past collector electrodes 192 at an imparted velocity (as indicated by fluid flow 199). Top and bottom walls (surfaces 193) of the flow channel through are generally formed of dielectric material and, as described in greater detail in commonly-owned, co-pending U.S. patent application Ser. No. 13/105,343, filed May 11, 2011, which is incorporated herein by reference, may be formed to shape the electric field and/or to provide a barrier to upstream migration of ions.

For example and briefly summarizing relative to the illustration of FIG. 3 (and of other embodiments that follow), dielectric surfaces 193 are provided on which charge (such as from positively charged ions generated at emitter electrode 191) tends to accumulate. Because dielectric surfaces 193 do not provide an attractive path to ground, a net positive charge tends to accumulate and thereafter operate electrostatically to repel like charges. As a result, dielectric surfaces 193 are electrostatically operative as a barrier to upstream ion migration. Upstream dielectric surfaces 193 also tend to electrostatically mask any otherwise attractive paths to ground, thereby shaping the previously described electric field in the primarily downstream direction toward collector electrodes 192. To improve performance, an air gap may be provided between leading edges of collector electrodes 192 and adjacent portions of dielectric surfaces 193. Optionally, in some embodiments, one or more conductive paths 194 to ground may be provided further upstream of dielectric surfaces 193 to capture ions that may nonetheless migrate upstream. In some embodiments, such a conductive path 194 to ground may be provided proximate an inlet vent. Further details and variations are described in the above-incorporated U.S. patent application Ser. No. 13/105,343.

Although illustrated in side cross-sectional view, it will be appreciated that a height increase (from H_{EHD} provided within the EHD channel defined generally at the perimeter by collector electrodes 192 to H_{HS} provided within the volume occupied by heat transfer fins 120) in the flow channel downstream of EHD air mover 110 provides an expansion region or chamber that increases cross-section of the flow channel and thereby reduces velocity of the motivated air flow 199 past heat transfer surfaces (e.g., ozone catalyst coated heat transfer surfaces 120). H_{EHD} will be understood to be a height of the flow path through EHD air mover 110 which, for a typical and generally rectangular EHD air mover cross section of the type illustrated, exhibits a flow cross-section of H_{EHD}*W_{EHD}, where W_{EHD} is the width of the flow path through EHD air mover 110. H_{HS} will be understood to be a height of the flow path through the heat sink defined by heat transfer surfaces 120 which, for generally rectangular cross section of the type illustrated, exhibits a flow cross-section of H_{HS}*W_{HS}, where W_{HS} is the width of the flow path through heat transfer surfaces 120. An increase in cross-sectional area of 20% to 80% can provide substantial (and corresponding) reductions in flow rate as motivated air flow 199 travels through heat transfer surfaces 120. In some cases, an increase in cross-sectional area of up to 200% may be employed to achieve desirable transit times through heat transfer surfaces 120.

Expansion region 310 is the portion of flow path in which a generally-smaller cross-section through EHD air mover 110 transitions to generally-larger cross-section through the fins of heat transfer surfaces 120. Although an increase in flow cross-section (and corresponding flow rate reduction) will be apparent to persons of ordinary skill in the art based on the H_{EHD} to H_{HS} increase illustrated in the view of FIG. 3, it will also be appreciated that increases in the width dimension (not apparent in the illustrated view) may further or alternatively contribute to the increase in flow cross-section (and corresponding flow rate reduction).

FIG. 4 depicts another illustrative electrohydrodynamic (EHD) fluid mover configuration in which an emitter electrode 191 and an array of rods or wires that constitute collector electrode 192A are energized to motivate fluid flow 199. The configuration also illustrates a variation on geometry of fins of the heat transfer surfaces that provides expansion of flow cross-section at least partially within the volume occupied by fins of heat transfer surfaces 120A themselves.

Operation of the EHD air mover, here EHD air mover 110A, is analogous to that previously described, although the array of wire-type collector electrodes 192A is instead employed. As before, a height increase (here, from H_{EHD} within the EHD channel to H_{HS} provided within the volume occupied by heat transfer fins 120A) in the flow channel downstream of EHD air mover 110A provides an expansion region or chamber that reduces velocity of the motivated air flow 199 past heat transfer surfaces (e.g., ozone catalyst coated fins of heat transfer surfaces 120A). Based in part on the illustration of FIG. 4, it will be appreciated that, in some embodiments, expansion region 310 may be provided (at least partially) within a volume associated with heat transfer surfaces.

Referring illustratively to either or both of FIGS. 3 and 4, it has been observed that velocity reductions in the EHD motivated air flow through such heat transfer surfaces 120, 120A can improve efficacy of ozone reducing material such as a manganese dioxide (MnO₂) thereon and provide a net reduction of ozone in ventilation system outflow. By reducing flow rate past the ozone catalyst coated heat transfer surfaces 120, 120A, dwell time over catalytic sites thereon is increased and diffusion effects allow ozone molecules in the motivated air flow to more effectively disperse over available catalytic sites of a fuller surface heat transfer surfaces 120, 120A (particularly in directions orthogonal to the motivated air flow 199). By providing an expansion region 310, is it possible to better utilize the catalytic sites provided on surfaces of short depth heat transfer fins (e.g., less that about 25 mm of depth in the direction of motivated air flow 199). In this way, a given or desired level of catalytic reduction in ozone may be achieved without resort to greater depth fins and without the additional flow resistance or drag that would otherwise be imparted thereby. Additionally and particularly in embodiments for small and/or thin form factor devices, reductions in overall length of the flow channel themselves may be advantageous.

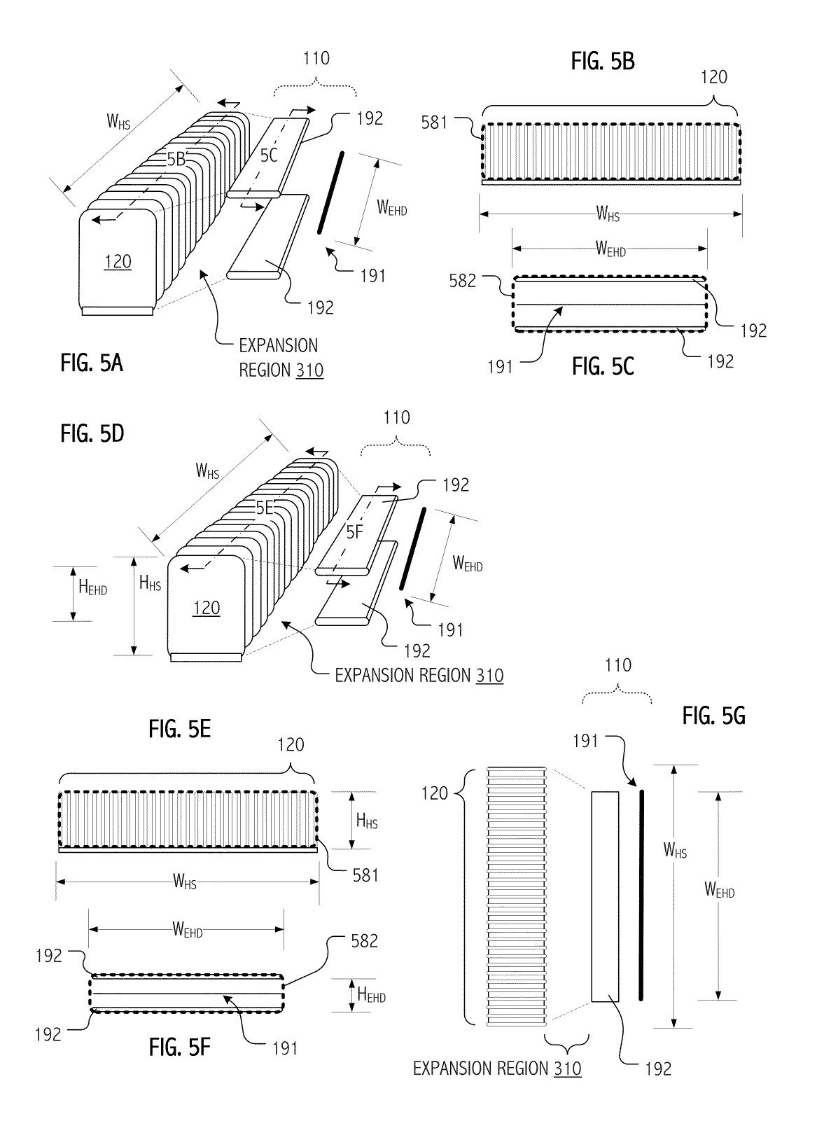

FIGS. 5A and 5D depict, in perspective view, further illustrative EHD fluid mover configurations in which an expansion region 310 is provided. Emitter and collector electrodes (191 and 192) and ozone catalyst coated heat transfer surfaces 120 are as previously illustrated and described relative to FIG. 3, while other features have been eliminated from the depiction so as not to obscure the views. Specifically, FIG. 5A depicts a configuration in which a lateral extent of the heat transfer fin presentation (W_{HS}) of heat transfer surfaces 120 is greater in a horizontally illustrated (width) dimension than lateral extent (W_{EHD}) of EHD fluid mover 110. FIGS. 5B and 5C are cross-sectional views corresponding to FIG. 5A, which graphically depict the generally-larger flow cross-section 581 through heat transfer surfaces 120 in juxtapose with the generally-smaller flow cross-section 582 through EHD fluid mover 110.

FIG. 5D likewise depicts a configuration in which a lateral and vertical extent (W_{HS}, H_{HS}) of the heat transfer fin presentation of heat transfer surfaces 120 is greater than corresponding extents (W_{EHD}, H_{EHD}) of EHD fluid mover 110. FIGS. 5E and 5F are cross-sectional views corresponding to FIG. 5D, which again depict the generally-larger flow cross-section 581 through heat transfer surfaces 120 in juxtapose with the generally-smaller flow cross-section 582 through EHD fluid mover 110. Finally, FIG. 5G is a top, plan view corresponding to both FIGS. 5A and 5D. Note that, while FIGS. 5A-5G illustrate using a fin geometry consistent with that introduced in FIG. 3, alternative fin geometries (such as described in an illustrated herein) are envisioned and, based on the present description, will be appreciated by persons of ordinary skill in the art. In variations that include fin geometries analogous to that illustrated in FIG. 4, it will be appreciated that the relevant generally-larger flow cross-section through heat transfer surfaces 120A may be taken downstream of leading edges of the heat transfer fins.

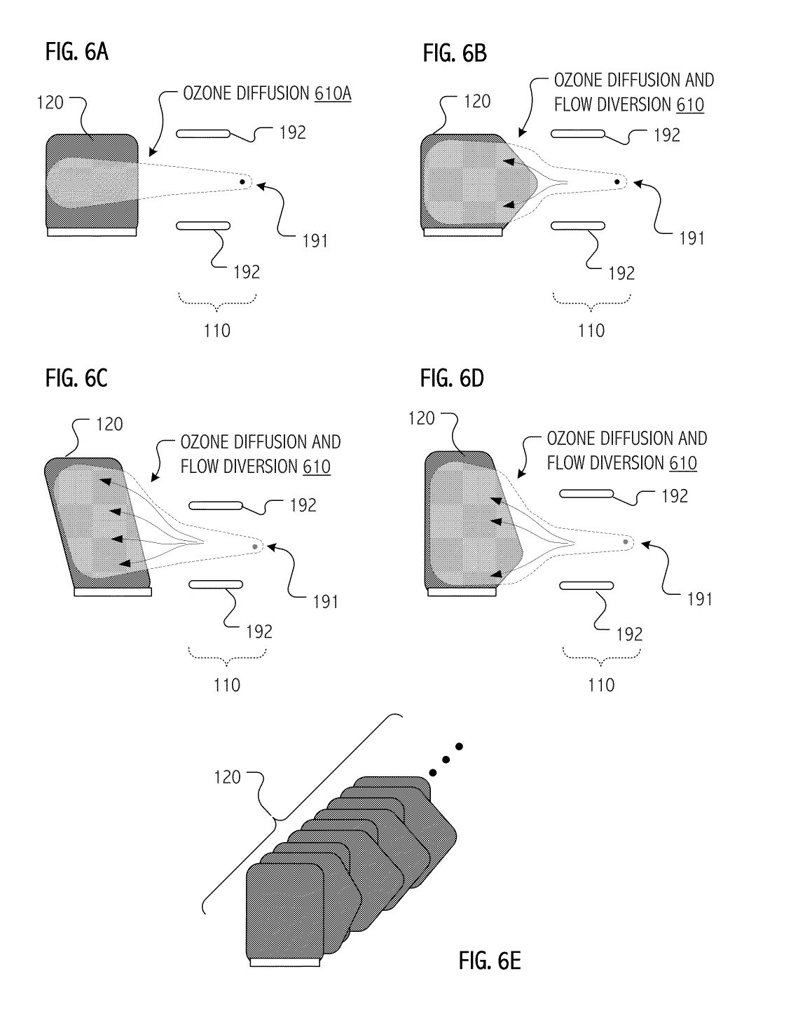

Because ozone is formed primarily in plasma conditions within a narrow corona discharge region closely proximate the surface of an emitter electrode, ozone tends to be spatially concentrated (at least initially) in the motivated air flow and tends to diffuse outward (e.g., from a centerline through an emitter electrode) as flow travels downstream and through the heat transfer surfaces 120, 120A. FIG. 6A illustrates (in side cross-section) diffusion 610A in the generally laminar downstream flow motivated by EHD fluid mover 110. Notably, in some cases or variations of the designs described herein, ozone may remain spatially concentrated as it travels (in the motivated airflow) through ozone catalyst coated heat transfer surfaces 120. As a result, at least a portion of the ozone catalyst coated heat transfer surfaces may be less than fully utilized. Although expansion of the flow path (such as described above) can itself contribute to the spatial dispersion of ozone in the flow path, in some embodiments or designs, it is desirable to include a flow diversion feature such as an inclined presentation and/or protuberant presentation of leading edges of heat sink fins.

FIGS. 6B-6D depict illustrative (though non exhaustive) variations on use of inclined presentation (see FIGS. 6C and 6D) of leading edges of heat sink fins and/or protuberant presentation thereof (see FIGS. 6B and 6D) so as to add a flow diversion contribution to basic diffusion and/or flow path expansion processes and thereby improve spatial dispersion of the ozone over a more substantial portion of the ozone catalyst coated heat transfer surfaces 120. Of course, all fins of heat transfer surfaces 120 need not exhibit the same inclined and/or protuberant presentation, and FIG. 6E depicts (in perspective view) one exemplary array of heat sink fins in which only a subset present a protuberant flow diverting leading edge profile and in which, amongst that subset, degree of protuberance is spatially varied.

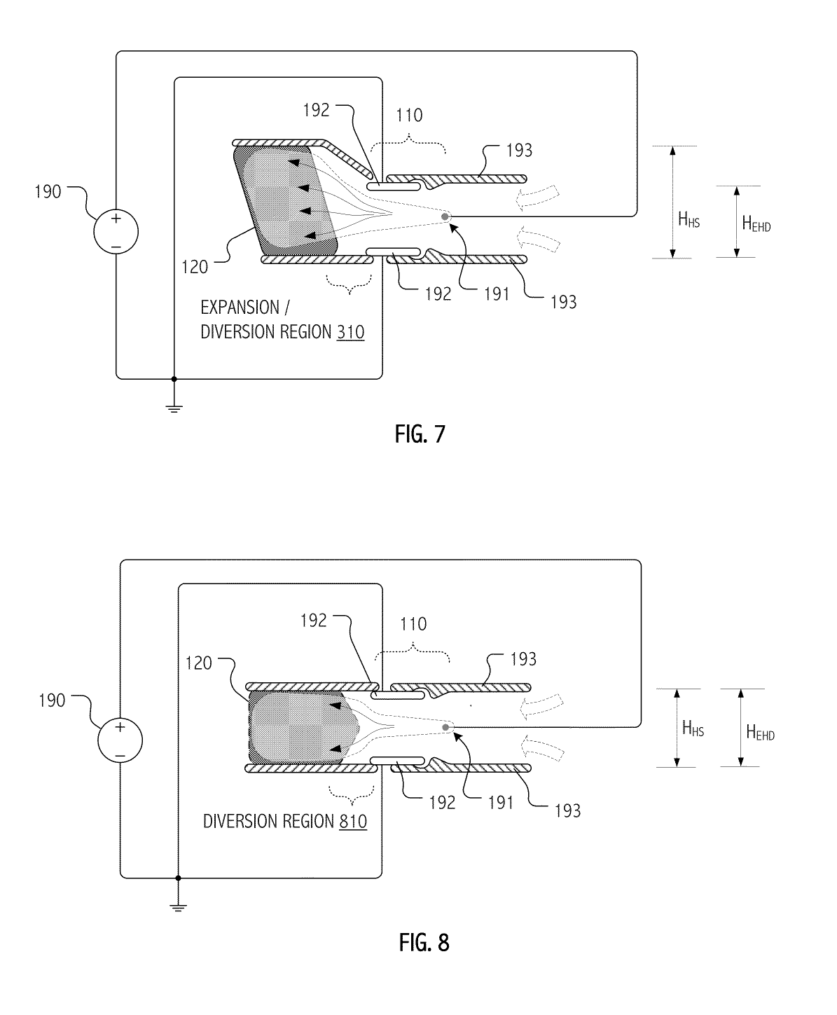

FIG. 7 depicts yet another illustrative EHD fluid mover configuration in which an emitter electrode 191 and collector electrodes 192 are energized to motivate fluid flow and which includes (as illustrated in side cross-sectional view) an expansion and flow diversion region 310 that is provided in accordance with some embodiments of the present invention(s). The depicted configuration illustrates use of an inclined presentation of leading edges of tall (H_{HS}>H_{EHD}) heat sink fins to improve ozone reduction efficacy by increasing both area and the proportion of ozone catalyst coated heat transfer surfaces 120 over which ozone is dispersed based on expansion, diversion and/or diffusion effects, but without a flow impedance increasing addition to the effective depth of heat transfer surfaces 120 in the direction of motivated fluid flow.

Operation of EHD air mover 110 is analogous to that previously described. As before, a height increase (from H_{EHD} provided within the EHD channel to H_{HS} provided within the volume occupied by heat transfer fins 120) in the flow channel downstream of EHD air mover 110 provides an expansion region or chamber that reduces velocity of the motivated air flow 199 past heat transfer surfaces (e.g., ozone catalyst coated fins of heat transfer surfaces 120). However in addition, the inclined presentation of leading edges of heat sink fins tends to divert a portion of the motivated flow upward in the flow channel to more completely and uniformly disperse over upper portions of heat transfer surfaces 120.

Velocity reductions in the EHD motivated air flow through such heat transfer surfaces 120 together with dispersion of spatial concentrations of ozone tends to improve efficacy of ozone reducing material such as a manganese dioxide (MnO₂) thereon and tends to provide a net reduction of ozone in ventilation system outflow. As before, by reducing flow rate past the ozone catalyst coated heat transfer surfaces 120, dwell time over catalytic sites thereof is increased and diffusion effects (together with flow diversion described above) allow ozone molecules in the motivated air flow to distribute more evenly over available catalytic sites of a fuller portion of heat transfer surfaces 120. By providing an expansion/diversion region 310, is it possible to better utilize the catalytic sites provided on surfaces of short depth heat transfer fins (e.g., less that about 25 mm of depth in the direction of motivated air flow 199). In this way, a given or desired level of catalytic reduction in ozone may be achieved without resort to greater depth fins and without the additional flow resistance or drag that would be imparted thereby. As before, in embodiments for small and/or thin form factor devices, reductions in overall length of the flow channel may be desirable as well.

FIG. 8 depicts still another illustrative EHD fluid mover configuration in which an emitter electrode 191 and collector electrodes 192 are energized to motivate fluid flow and which includes (as illustrated in side cross-sectional view) a flow diversion region 810 that is provided in accordance with some embodiments of the present invention(s). Note that in some embodiments, a flow diversion feature such as the illustrated protuberance may be employed without an expansion region (or at least without a substantial increase in height, H_{HS}, provided within the volume occupied by heat transfer surfaces 120 as compared with height, H_{EHD}, provided within the channel of EHD air mover 110).

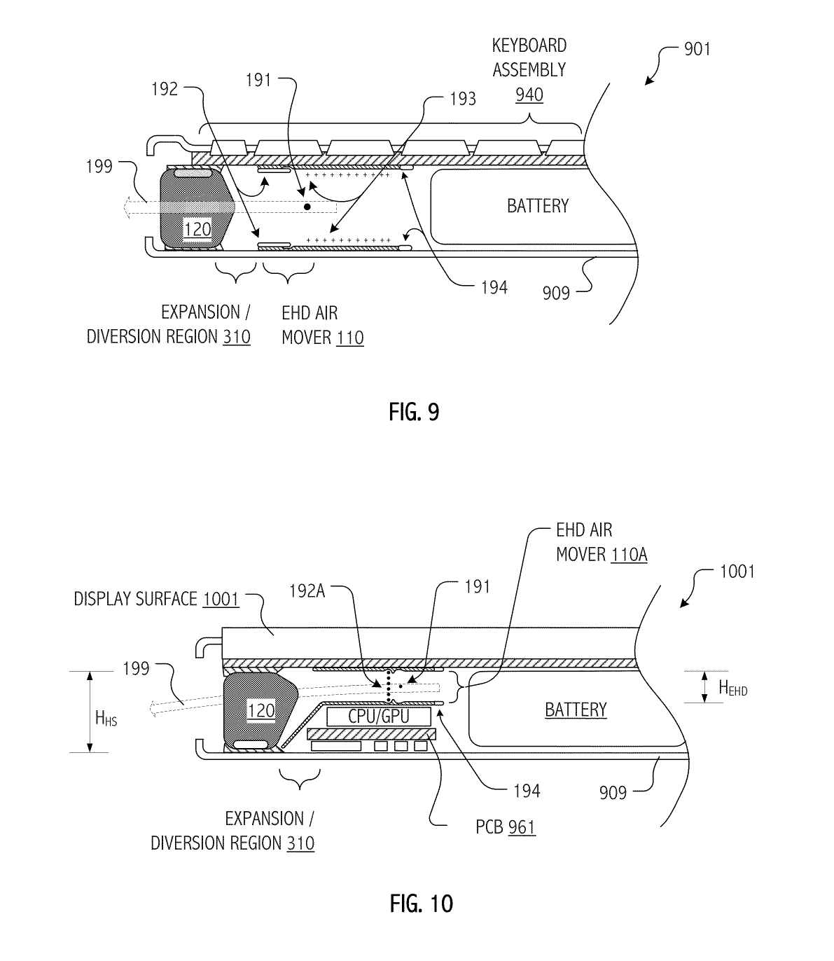

FIGS. 9 and 10 depict illustrative electronic device embodiments in which an EHD fluid mover 110, 110A and heat transfer surface 120 configurations are provided in accordance with some embodiments of the present invention(s). In the illustration of FIG. 9, a substantial entirety of the interior portion of a vertical cross-section (typically 10 mm or less) through an electronic device is occupied by the flow channel through EHD fluid mover 110 and heat transfer surfaces 120. The illustrated configuration (which illustratively includes a keyboard assembly 940 at the upper surface thereof) is consistent with some laptop and notebook computer realizations of an electronic device in which a thermal management assembly including EHD fluid mover 110, heat transfer surfaces 120, and suitable high voltage power supply circuits and controls are configured to provide a ventilation path with generally silent, forced-air convective heat transfer to cool one or more heat sources therewithin.

A flow diverting leading edge presentation of at least some fins of heat transfer surfaces 120 is employed together (optionally) with a lateral expansion in flow path not visible in the illustrated cross-section (see expansion/diversion region 310) to disperse spatial concentrations of ozone molecules over ozone catalyst bearing material such as manganese dioxide (MnO₂) on heat transfer surfaces 120 and to thereby provide a net reduction of ozone in ventilation system outflow. Of course, based on the description herein, persons of ordinary skill in the art will appreciate adaptations to other electronic device configurations with potentially different form factors and with or without the illustrated keyboard assembly.

FIG. 10 likewise depicts an electronic device configuration in which only a sub-portion of the interior portion of the vertical cross-section (perhaps 5 mm or less) through an electronic device is occupied by the flow channel through EHD fluid mover 110A, while the flow path expands in the height dimension (H_{HS}>H_{EHD}) and includes a flow diversion feature (see expansion/diversion region 310) to disperse spatial concentrations of ozone molecules over ozone catalyst bearing heat transfer surfaces 120. The illustrated configuration (which includes a display surface 1001 such as an edge- or back-lit LCD touchscreen at the upper surface thereof) is consistent with some pad- or tablet-type computer realizations of an electronic device in which a thermal management assembly including EHD fluid mover 110, heat transfer surfaces 120, and suitable high voltage power supply circuits and controls are configured to provide a ventilation path with generally silent, forced-air convective heat transfer to cool one or more heat sources therewithin. Heat sources so cooled may include processor(s) CPU/GPU, memory, illumination sources for display surface 1001 and/or other devices or components. Of course, based on the description herein, persons of ordinary skill in the art will appreciate adaptations to other electronic device configurations (with or without the illustrated display surface and/or PCB 961 mounted processor(s) CPU/GPU, integrated circuits and discrete electronics components).

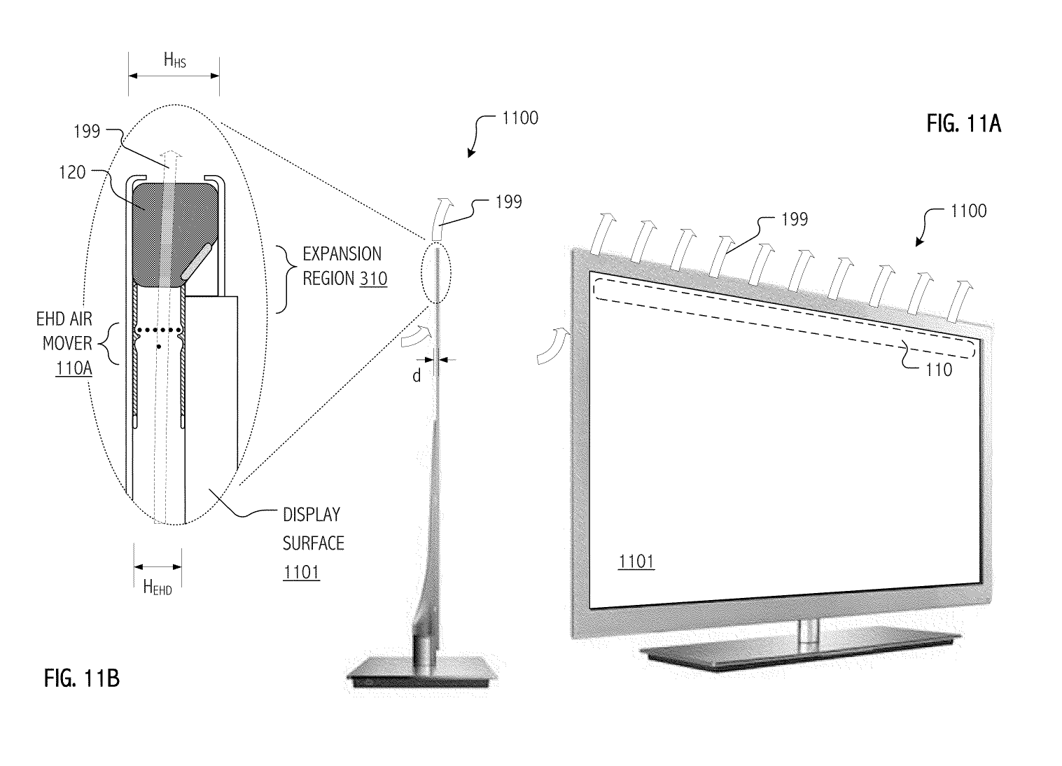

Finally, FIGS. 11A and 11B depict an illustrative, display-type electronic device embodiment in which an illustrative EHD fluid mover 110A configuration and heat transfer surfaces 120 are provided in accordance with some embodiments of the present invention(s) to cool one or more heat sources therewithin. As before, only a sub-portion of the interior portion of the cross-section (perhaps 10 mm or less) through the display-type electronic device 1001 is occupied by the flow channel through EHD fluid mover 110A, while the flow path for motivated air flow 199 expands (H_{HS}>H_{EHD}) to reduce flow rate and thereby increase dwell time and facilitate diffusion spatial concentrations of ozone over catalytic sites of ozone catalyst bearing heat transfer surfaces 120. The illustrated configuration (which includes a display surface 1101 such as an edge- or backlit LCD touchscreen at the front surface thereof) is consistent with some television, monitor, display or all-in-on computing device realizations of an electronic device in which a thermal management assembly including EHD fluid mover 110, heat transfer surfaces 120, and suitable high voltage power supply circuits and controls are configured to provide a ventilation path with generally silent, forced-air convective heat transfer to cool one or more heat sources therewithin.

In each of the forgoing electronic device examples, particular EHD air mover configurations, heat sink fin geometries, ventilation path topologies and dimensions, as well as selection of placement of components unrelated to the ventilation pathways is purely illustrative and not limited to one electronic device type or another.

### Further Description and Examples

A corona is a gas in an energetically excited state. There are many ways of generating a corona. One involves applying a high voltage between two electrodes. The electrodes can take many forms. One configuration is where the electrode connected to the negative voltage of the supply has a small radius of curvature and the electrode connected to the positive voltage of the supply has a large radius of curvature. A small radius electrode is typified by a fine wire and a large radius electrode by a flat plate. The wire is typically very long compared to its diameter. In the foregoing description, wire-plate type EHD air movers are the illustrated corona generating devices. However, based on the description herein, persons of ordinary skill in the art will appreciate applications to other EHD air mover designs.

As previously explained, the wire-to-plate corona device of type described herein will, when suitably energized, create a flow of air in the general direction from the wire to the plates. In effect, the device can be considered as a “fan”, but one with no moving parts. As is well known, fans are often used to expel hot air and provide cooling to spaces like rooms and housings containing electronic components, like laptop computers. Where a wire-to-plate corona device is used to provide this function it is sometimes referred to as a ‘silent air cooling’ (SAC) device, owing to the complete absence of noise compared with a mechanical fan.

One reason why SAC devices are indeed silent is that the air flow they produce is substantially laminar; the air flow occurs due phenomena associated with the electric field gradient in the device and there are essentially no obstructions to this flow other than the exceedingly fine wire, typically around 25 microns diameter and the two flat plates that are normal to the air flow, when viewed in section.

A common use of fans, including SAC devices, is to cause a draft of air to flow past the fins of a heat exchanger. Generally, the fan is selected to be of comparable dimensions to the heat exchanger. This is for reasons of efficiency. If the fan is smaller than the heat exchanger, air will not be blown over the entire heat exchanger surface so heat transfer from the heat exchanger to the air will be below optimum. Conversely, if the fan is larger than the heat exchanger, some air will bypass the heat exchanger and the energy expended to move that volume of air is wasted.

It is common for there to be a shape mismatch between a rotary fan and a heat exchanger. However, such mismatch is conventionally purely for reasons of cost. Rotary fans are radially symmetric so have a circular aperture. Heat exchangers are mostly made of extruded aluminum so have rectangular cross-section. Consequently, one of the most common combinations is for the rotary fan to have the same diameter as the edge of the heat exchanger. This results in the corners of the heat exchanger having only a small interaction with the airflow, but is substantially cheaper than making a round heat exchanger.

A further common approach when using a fan in combination with a heat exchanger is for these two components to be closely coupled; that is, either abutted or spaced only a small distance apart. This is because best heat transfer between a heat exchanger and an air flow is obtained when the air flow has high volume per unit time and is turbulent. Having a high flow rate ensures the temperature of the air does not change greatly on contact with the heat exchanger. As is well known from the underlying physical principles, this condition enhances the heat exchange between the air and the heat exchanger. Turbulent air flow (e.g., that exiting the aperture of a rotary fan) helps mitigate thermal gradients in the air and reduces the thickness of the boundary layer adjacent to the heat exchanger surface, both of which improve thermal transfer between the air and the heat exchanger.

Spacing the fan a distance from the heat exchanger and coupling them using a duct is sometimes done for aesthetic or other design considerations. For example, a noisy fan might be located outside of a building rather than inside; one large fan might be used to pass air through several remote heat exchangers. Often in laptop and netbook computers, the heat exchanger is located along one edge of the enclosure but the fan is placed towards the centre of the keyboard with the spaces between the keys forming a “grill” on the inlet to the fan. By placing the fan centrally a large inlet grill is obtained, so reducing the flow obstruction on the inlet. However separating the fan from the heat exchanger is generally undesirable. The coupling space or duct causes drag on the air flow, while some types of turbulence, such as eddies from the fan blades are given time and space to abate. Combined, these effects serve to reduce the air flow and decrease the system efficiency.

As alluded to above, as an air moving device, a SAC device differs from a fan in several key aspects. These are that device has a rectangular profile, like a heat exchanger, the blown air flow is substantially laminar and a SAC device operates at ‘low head’; that is, the flow rate declines precipitously if the device experiences back pressure. Consequently, close coupling of a SAC device to a heat exchanger of similar size results in inefficient heat transfer between the air and the heat exchanger. Improvements are sought, and herein described, that account for substantial differences in the operational characteristics of EHD air movers, as contrasted with a conventional mechanical fan or blower.

In some embodiments in accordance with the present invention(s), an SAC device is used to facilitate the flow of air through a heat exchanger, where the SAC device and the heat exchanger are deliberately spaced a distance apart and coupled by a duct. Preferably the heat exchanger is larger than the SAC device so the coupling duct acts also as an expansion chamber. The preceding description of embodiments illustrated in FIGS. 3, 4, 5A-5G, 6A-6E, 7, 8, 9, 10 and 11A-11B details various generally preferred heat exchanger configurations that might be used in conjunction with a SAC device.

For example, in some embodiments illustrated and described herein, the heat exchanger is generally of a same height as the SAC device, but considerably wider and is coupled to the SAC device by a duct that permits the air flow to expand laterally. In such a configuration the heat exchanger is said to have a relatively high aspect ratio (width is greater than length). This aspect is advantageous for use in combination with a SAC device since it results in low back pressure for a given air volume passed between the fins per unit time and also a low air velocity past the heat exchanger surface. For reasons that will be understood by persons having access to the present disclosure, both effects are a direct consequence of the unobstructed pathway for air flow through the heat exchanger being large in relation to the dimensions of the SAC device.

Low air velocity past the surface of the heat exchanger can be important in conjunction with certain types of SAC device, especially those which generate ozone. High concentrations of ozone in ambient air are generally undesirable and diminution of the concentration of this molecule in the exhaust air stream is sometimes required. Where the heat exchanger surface is placed on the exhaust side of the SAC device, its surface may be coated with a catalyst based on manganese dioxide. In general, a catalyst based on manganese dioxide will reduce the concentration of ozone in a passing air flow provided the minimum transit time is about 0.3 seconds. Slowing the air flow by use of an expansion chamber and a heat exchanger that is larger than the SAC device, helps fulfill this design goal.

In other embodiments illustrated and described herein, a heat exchanger that may be used in conjunction with a SAC device, is of the generally the same width as the SAC device, but considerably taller is coupled to the SAC device by a duct that permits the air flow to expand vertically. The expansion duct provides the similar benefits as the preceding example since the back pressure on the SAC device will be small and velocity of air flow through the heat exchanger low.

A third possibility, in terms of altering the profile of the heat exchanger to match the characteristics of the SAC device is to increase the depth of the heat exchanger. This increases the transit time of the air flow, which can be beneficial, but also increases the flow resistance, in other words the back pressure. This arises due to drag that exists where there is relative motion between a fluid or gas and a solid surface. The increase in back pressure causes the SAC device to become less efficient at converting electrical energy in to a volume of displaced air. Accordingly, such configurations may be suboptimal, particularly absent other design accommodations described herein.

Given the foregoing, another permutation of the invention is to form a duct between a SAC device and a heat exchanger by displacing the principal heat transfer surfaces of the heat exchanger, namely its fins, along the direction of air flow. This arrangement works more effectively than when the SAC device is abutted to the heat exchanger. This is for two reasons. Unlike a fan, the air plume exhausted from a SAC device is ostensibly laminar. Laminar flow of a body of air, even in a confined space like a duct is disrupted quite easily. For example by turbulence arising from imperfections on the confining surfaces, temperature gradients etc. Thus, the longer is the duct the greater is the chance that the laminar flow will be partly disrupted by the time the air reaches the heat exchanger. Mild turbulence in an air flow interacting with a heat exchanger is beneficial. Turbulent air flow helps mitigate thermal gradients in the air and reduces the thickness of the boundary layer adjacent to the heat exchanger surface, both of which improve thermal transfer between the air and the heat exchanger. Similarly, when the air flow contains ozone and the surface of the heat exchanger is coated with a catalyst that converts ozone to oxygen, a performance gain results when the air flow is slightly turbulent compared with when it is laminar. Provided the turbulence is mild the increase in flow restriction, arising from turbulent drag, will be small and well within the limits of the SAC device to cope with the slightly increased back pressure.

The above discussion reference was made to a duct between the SAC device and the heat exchanger. Preferably, this duct is a discrete component. However, the duct can equally be other components that are placed in appropriate locations that have facing external surfaces. These surfaces form a shaped space or chamber between the SAC device and the heat exchanger. For example, one (e.g., lower) surface of an expansion chamber may be formed over printed circuit board carrying electronic components, while another (e.g., upper) surface may be formed over the underside of a touch screen display or keyboard assembly.

Similarly, while in the preceding discussion and drawings, the duct is shown to have simple shape, it will be apparent to persons of ordinary skill in the art having access to this disclosure that the duct could have a more complex profile, including bends, changes in section, protrusions, blind cavities, splits and joins etc. as may required for adaptation to a particular device or deployment, without departing from the spirit or scope of one or more of the present invention(s). While drawings may show small gaps or other separation between the various structures, this is done to aid clarity. In reality, the presence of gaps would permit part of the airflow to travel in undesired directions that would adversely affect performance. Preferably the components shown in the illustrations are typically bonded together, sealed, or held together by mechanical fastenings, without gaps, to form a flow path between inlet and outlet portions of a device enclosure.

### Other Embodiments

While the techniques and implementations of the EHD devices and heat transfer surfaces discussed herein have been described with reference to exemplary embodiments, it will be understood by those skilled in the art that various changes may be made and equivalents may be substituted for elements thereof without departing from the scope of the appended claims. In addition, many modifications may be made to adapt a particular situation or material to the teachings without departing from the essential scope thereof. Therefore, the particular embodiments, implementations and techniques disclosed herein, some of which indicate the best mode contemplated for carrying out these embodiments, implementations and techniques, are not intended to limit the scope of the appended claims.

What is claimed is:

1. A ventilation path comprising:
an electrohydrodynamic (EHD) air mover having, at its output, a flow channel characterized by a first cross-section through which, when the EHD air mover is energized, motivated air flow is essentially laminar;
an array of spaced apart heat transfer fins that present to the motivated air flow a second cross-section larger than the first cross-section; and
an expansion region of increasing cross-section along the path of the motivated air flow from the output of the EHD air mover toward the second cross-section.

2. The ventilation path of claim 1,
wherein the increasing cross-section provided within the expansion region provides for a reduction of at least about 20% to 80% in velocity of the motivated air flow at the second cross-section as compared with velocity of the motivated air flow at the first cross-section.

3. The ventilation path of claim 2,
wherein the output of the EHD air mover coincides with a trailing edge of at least a pair elongate collector electrode surfaces oriented parallel to an upstream emitter wire having a diameter of less than about 40 μm; and
wherein the first cross-section is generally rectangular with a height of less than about 10 mm and a length:height ratio of at least 10:1.

4. The ventilation path of claim 2,
wherein the first and second cross-sections have substantially similar heights, ±10%, but length of the second cross-section substantially exceeds that of the first cross-section.

5. The ventilation path of claim 2,
wherein the first and second cross-sections have substantially similar lengths, ±10%, but height of the second cross-section substantially exceeds that of the first cross-section.

6. The ventilation path of claim 2,
wherein at least a substantial portion of surfaces of the heat transfer fins exposed to the motivated air flow are coated with an ozone reducing catalyst; and
wherein mean transit time of the motivated air flow through the heat transfer fins is at least about 0.3 seconds.

7. The ventilation path of claim 6,
wherein the heat transfer fins extend no more than about 25 mm along the path of the motivated air flow.

8. The ventilation path of claim 1,
wherein at least a substantial portion the expansion region is between the output of the EHD air mover and leading edges of the spaced apart heat transfer fins.

9. The ventilation path of claim 1,
wherein leading portions of at least some of the spaced apart heat transfer fins project into the expansion region.

10. The ventilation path of claim 1,
wherein a substantial entirety of the expansion region is between the output of the EHD air mover and leading edges of at least some of the spaced apart heat transfer fins.

11. The ventilation path of claim 10,
wherein height of the first cross-section at the output of the EHD is less than about 10 mm; and
wherein the second cross-section is at least about 20% to 80% larger than the first cross-section.

12. The ventilation path of claim 11,
wherein the second cross-section is at least about 20% to 200% larger than the first cross-section.

13. The ventilation path of claim 1,
wherein the expansion region encompasses leading portions of at least some of the spaced apart heat transfer fins.

14. The ventilation path of claim 1,
wherein leading edges of at least some of the spaced apart heat transfer fins are shaped or disposed to redirect at least a portion of the motivated air flow.

15. The ventilation path of claim 14,
wherein the shaping or disposition to redirect includes an angled presentation of the leading edges to the motivated air flow.

16. The ventilation path of claim 14,
wherein the shaping or disposition to redirect includes an upstream projection into the motivated air flow of at least some of the spaced-apart heat transfer fins.

17. The ventilation path of claim 14,
wherein the leading edges shaped or disposed to redirect are positioned within the ventilation path to coincide with a concentration in a non-uniform spatial distribution of ozone motivated air flow.

18. The ventilation path of claim 1,
wherein the increasing cross-section is provided in plural dimensions generally orthogonal to the path of the motivated air flow.

19. The ventilation path of claim 1, integrated in an electronic device as part of a thermal management subsystem thereof.

20. The ventilation path of claim 19, wherein at least a portion of a flow path defining boundary wall is provided by either or both of:
an enclosure of the electronic device; and
ductwork within the electronic device

21. The ventilation path of claim 1, embodied as part of a thermal management subsystem suitable for integration within in an electronic device between an inlet and an outlet ventilation boundary thereof.

22. The ventilation path of claim 21,
wherein at least a portion of a flow path defining boundary wall is provided by the thermal management subsystem itself.

23. A ventilation path comprising:
an electrohydrodynamic (EHD) air mover having, at its output, a flow channel characterized by a first cross-section through which, when the EHD air mover is energized, motivated air flow is essentially laminar and unidirectional;
an array of spaced-apart heat transfer fins that bear an ozone reducing catalyst and which present to the motivated air flow a second cross-section; and
a flow spreader introduced into the ventilation path downstream of the output of the EHD air mover, but no further downstream than a mid-channel leading edge of the spaced apart heat transfer fins.

24. The ventilation path of claim 23,
wherein the motivated air flow through the first cross-section exhibits a spatially non-uniform distribution of ozone; and
wherein the flow spreader diverts at least some of the motivated air flow from a region of generally higher ozone concentration such that a spatial distribution of ozone at the second cross-section is substantially more uniform than at the first cross-section.

25. The ventilation path of claim 23,
wherein the flow spreader is formed, at least in part, as a leading edge of at least some of the spaced-apart heat transfer fins shaped or disposed to contribute to the diversion.

26. The ventilation path of claim 25,
wherein the shaping or disposition to contribute to the diversion includes an upstream projection of at least some of the spaced-apart heat transfer fins.

27. The ventilation path of claim 25,
wherein the shaping or disposition to contribute to the diversion includes an angled presentation of the leading edges to the motivated air flow.

28. The ventilation path of claim 23,
wherein the EHD air mover includes a laterally elongate wire-type emitter electrode vertically positioned at or about a vertical midpoint in the flow channel; and
wherein the flow spreader is vertically positioned downstream of the emitter electrode to generally align and vertically coincide with a flow path of ozone generated proximate to the emitter electrode.

29. A method of making an electronic device, the method comprising:
introducing into a ventilation path of the electronic device (i) an electrohydrodynamic (EHD) air mover having, at its output, a flow channel characterized by a first cross-section through which, when the EHD air mover is energized, motivated air flow is essentially laminar and unidirectional and (ii) downstream of the EHD air mover, an array of spaced-apart heat transfer fins that bear an ozone reducing catalyst and which present to the motivated air flow a second cross-section, the EHD air mover and array of spaced-apart heat transfer fins separated by an expansion region of increasing cross-section along the path of the motivated air flow from the output of the EHD air mover toward the second cross-section; and
providing a flow spreader in the ventilation path downstream of the output of the EHD air mover, but no further downstream than a mid-channel leading edge of the spaced apart heat transfer fins.

30. The method of claim 29, wherein the electronic device is packaged as one of a computer, a laptop, notebook, tablet or handheld electronic device and a video display, and further comprising:
configuring the EHD device to provide the computer, laptop, notebook, tablet or handheld electronic device or video display with ventilating air flow.
